(19) United States
(12) Patent Application Publication
(10) Pub. No.: US 2008/0307666 A1
(43) Pub. Date: Dec. 18, 2008

(54) Measuring Band

(76) Inventors: Mattias Mattsson, Nykvarn (SE); Johnny Nyman, Nykvarn (SE)

Correspondence Address: YOUNG & THOMPSON, 209 Madison Street, Suite 500, ALEXANDRIA, VA, 22314, US

(21) Appl. No.: 11/667,130

(22) PCT Filed: Nov. 10, 2005
(86) PCT No.: PCT/SE2005/001688

§ 371 Date: Sep. 28, 2007

(30) Foreign Application Priority Data
Nov. 11, 2004 (SE) 0402737-1

(51) Int. Cl. G01B 3/10

(52) U.S. Cl. 33/759

(57) ABSTRACT

A measuring band for marking of centre to centre (C/C) distances, especially in connection with building frameworks, the measuring band at least on one side being provided with information, a number of lines (1, 3, 5) extending transverse to the longitudinal direction of the measuring band. The invention also relates to a method for the marking of centre to centre (C/C) distances. It is significant of the measuring band that adjacent lines (1, 3, 5) are located at a distance from each other of at least 30 cm, the distance between adjacent measuring indicias (1, 3, 5) is the same, and a marking symbol (X) is provided on the same side of each line (1, 3, 5).

### TECHNICAL FIELD OF THE INVENTION

The present invention relates to a measuring band for marking of centre to centre (C/C) distances, especially in connection with building of frameworks, said measuring band at least on one side being provided with information, that the measuring band is provided with a number of measuring indicias, and that at least one piece of measuring information is provided adjacent to each measuring indicia. The invention also relates to a method for marking of centre to centre (C/C) distances between building elements, said method using a measuring band.

### PRIOR ART

When measuring centre to centre (C/C) distances, e.g. in connection with the erection of building frameworks, folding rules and measuring rods are normally used, the measuring rods having a certain length that corresponds to a desired centre to centre (C/C) distance. When measuring and marking of centre to centre (C/C) distances by means of a folding rule it is difficult to have the centre to centre (C/C) distances exactly the same. When using a measuring rod the craftsman faces a problem when simultaneously holding the measuring rod and nailing the building element, e.g. a stud.

From CA 2 274 383 a measuring band for building frameworks is previously known. This measuring band has different distances between adjacent measuring indicias. This brings about an obvious risk that different centre to centre (C/C) distances are mixed up. The measuring band according to the present invention has a constant distance between adjacent measuring indicias. Besides, the measuring band according to CA 2 274 383 is intended to be used several times. This means a handling that is essentially more time-consuming than as regards the handling of the measuring band according to present invention, the last mentioned measuring band being disposable. The measuring band according to CA 2 274 383 has a permanent starting point contrary to the measuring band according to the present invention where the user creates a new starting point for each marking situation.

From for instance U.S. Pat. No. 4,149,320, WO 99/64813 and GB 2 372 572 measuring bands are previously known that have a measuring scale on one side and an adhesive on the other side. These measuring bands may easily be applied on a base by urging the side having the adhesive against the base. In connection therewith the base must be suitable to cooperate with the adhesive, i.e. there should be a proper attachment of the measuring band on the base.

### OBJECTS AND FEATURES OF THE INVENTION

A primary object of the present invention is to expose centre to centre (C/C) distances for elements being included in a building framework, this being effected in a user-friendly way by means of a measuring band, the building elements preferably being studs or a secondary spaced boarding.

A further object of the present invention is that the measuring band should be extremely simple to apply/mount.

Further an object of the present invention is that the adjustment of the centre to centre (C/C) distances adjacent to windows and doors is simplified.

Still an object of the present invention is that according to a preferred embodiment the one and same measuring band is used in connection with different centre to centre (C/C) distances.

At least the primary object of the present invention is realized by means of a measuring band and a method that has been given the features of the appending independent claims. Preferred embodiments of the invention are defined in the dependent claims.

### BRIEF DESCRIPTION OF THE DRAWINGS

Below preferred embodiments of the invention will be described, reference being made to the accompanying drawings, where:

FIG. 1 schematically shows a preferred embodiment of a portion of a measuring band according to the present invention;

FIG. 2 shows how the measuring band according to the present invention is mounted on the lower side of a roof truss;

FIG. 3 shows a detail of FIG. 2;

FIG. 4 shows how a secondary spaced boarding is mounted on the lower side of the roof truss; and

FIG. 5 shows how the measuring band according to the present invention is mounted at the top and at the bottom in connection with the erection of studs for a wall.

### DETAILED DESCRIPTION OF PREFERRED EMBODIMENTS OF THE INVENTION

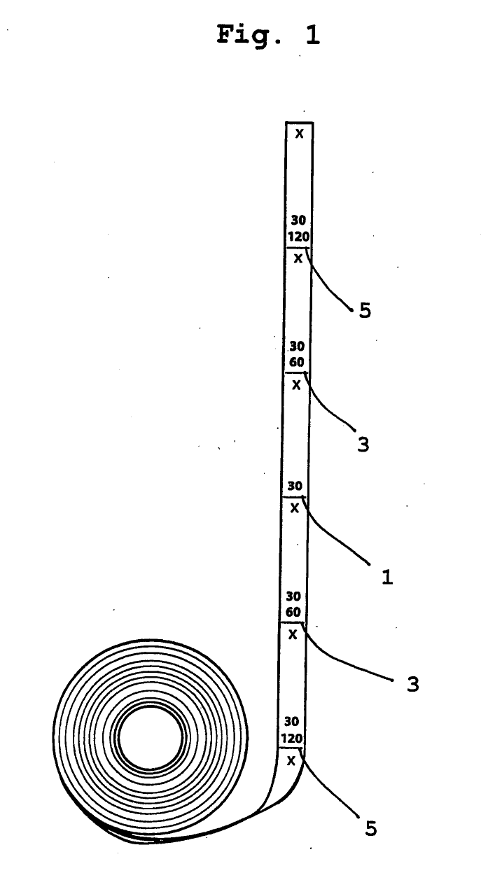

An embodiment of a measuring band according to the present invention is shown in FIG. 1. The measuring band is manufactured from a material that, during normal use, is not extensible in its longitudinal direction. In exemplifying and non-restricting purpose a silicone coated paper may be mentioned as a suitable material for the measuring band according to the present invention. When manufacturing a number of prototypes bands have been used that for instance are used as binding bands for goods on pallets.

As is evident from FIG. 1 the measuring band is on one side provided with measuring indicias. These measuring indicias constitute a number of lines 1, 3, 5 extending transverse to the longitudinal direction of the measuring band. On one side of each line 1, 3, 5, the lower side in FIG. 1, a marking, in the shape of an “X”, is provided. The purpose of this marking is to instruct the user on which side of the line 1, 3, 5 the elements are to be placed, said elements being arranged at a certain mutual centre to centre (C/C) distance by means of the measuring band. For instance, it may be the question of vertical studs in a wall framework and in such a case all studs are placed on the same side of the line 1, 3, 5.

On the other side of the line 1, 3, 5, in FIG. 1 the upper side, a number of pieces of measuring information are provided, said pieces of information representing different centre to centre (C/C) distances. In the shown embodiment the presented centre to centre (C/C) distances are 30 cm, 60 cm and 120 cm. A centre to centre (C/C) distance of 30 cm is suitable when mounting a so called secondary spaced boarding on the lower side of roof trusses, a centre to centre (C/C) distance of 60 cm is frequent when erecting studs of a wall framework and a centre to centre (C/C) distance of 120 cm is frequent as regards roof trusses.

As is evident from FIG. 1 the centre to centre (C/C) distance “30” is present at all lines 1, 3, 5. The reason therefore is that the distance between two adjacent lines is 30 cm. The centre to centre (C/C) distance “60” is present at every second line 3, i.e. the distance between the lines that are marked by “60” is 60 cm. The centre to centre (C/C) distance “120” is present at every fourth line 5 and consequently the distance between the lines that are marked by “120” is 120 cm. As is evident from FIG. 1 the pieces of measuring information “60” and “120” are not located at the same line, this reducing the risk of a mix-up.

When the measuring band according to the present invention is to be used the following action is taken. The user cuts the measuring band at the piece of measuring information that corresponds to the centre to centre (C/C) distance in question. If for instance the centre to centre (C/C) distance of 60 cm is in question the user cuts the measuring band at the second line from above in FIG. 1, i.e. at the line 3 that is provided with the pieces of measuring information “30” and “60”. Then the measuring band is mounted with the cut off end in the starting point of the distance/the length that is to be marked. When the measuring band is mounted on the entire distance/length that is to be marked the measuring band is again cut beyond the end point of the distance/the length that is to be marked. Then the user uses every second line 3, i.e. the lines that are provided with the piece of measuring information “60”. If it on the other hand is the question of the centre to centre (C/C) distance 120 cm the user cuts the measuring band at the top line 5 in FIG. 1. Then every fourth line 5 is used, i.e. the lines that are provided with the pieces of measuring information “120”. The cut at the lines 1, 3, 5 are effected in such a way that the marking “X” remains on the cut measuring band.

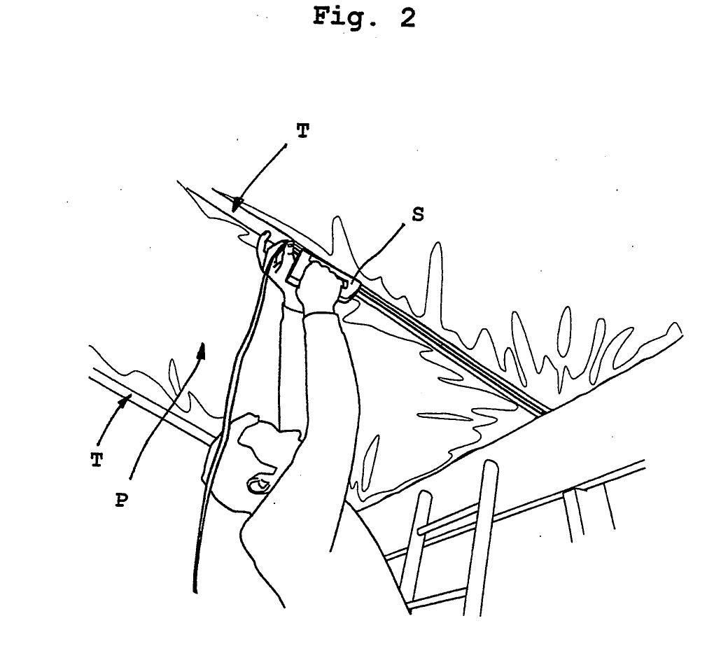

In FIG. 2 it is shown how a measuring band according to present invention is mounted on the lower side of a roof truss T. Insulation and a plastic sheet P is mounted between the roof trusses T, the plastic sheet being shown schematically in FIG. 2. Normally, the roof trusses T are located at a centre to centre (C/C) distance of 120 cm. This means that the user cuts the measuring band at a line 5 and the “X” will remain on the measuring band.

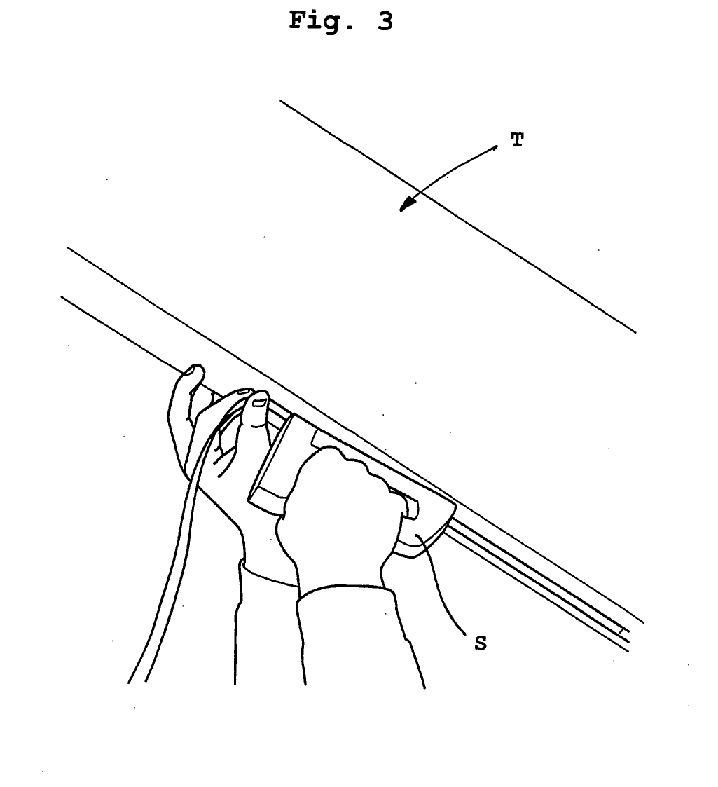

As is shown more in detail in FIG. 3 the user mounts the measuring band by means of a staple gun S, the measuring band according to the invention normally being permanently fixed, i.e. the measuring band being disposable and thus not dismounted. The measuring band according to the present invention is normally mounted along the entire lower side of the roof truss T. The cut end of the measuring band, the cut being at the line 5, is first mounted at the lowest end of the roof truss T. Then the rest of the measuring band is nailed to the lower side of the roof truss T, up to the highest end of the roof truss T. In a corresponding way a measuring band is mounted on the other half of the roof truss T.

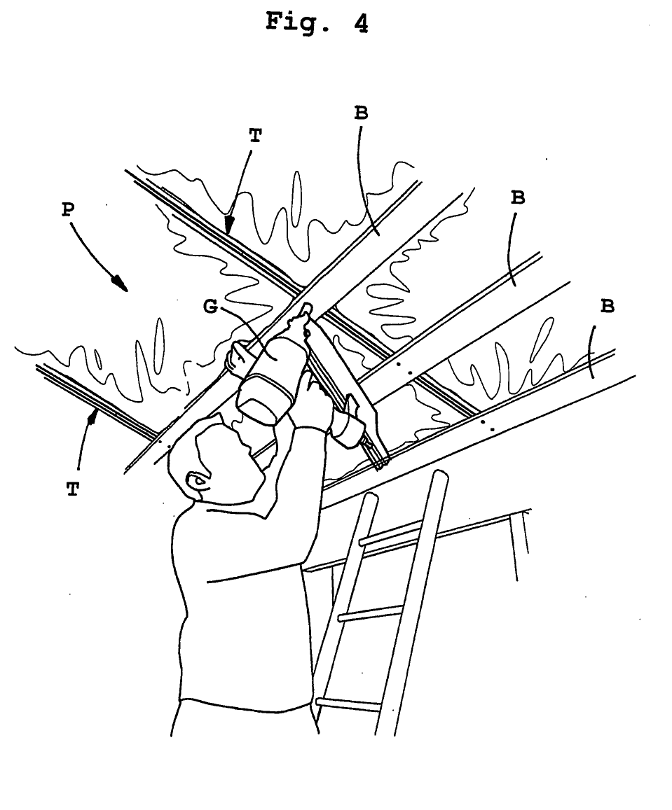

When measuring bands are mounted at the lower side of all roof trusses T a so called secondary spaced boarding is mounted at the lower side of the roof trusses T. This is illustrated in FIG. 4. In connection therewith the craftsman normally starts at the lowest end of the roof trusses, i.e. at the line 5, and the first board B of the secondary spaced boarding is mounted on top of the “X” on the measuring band. Normally, the mounting of the board B takes place by nailing and a portable nailing machine G may be used, see FIG. 4. The subsequent boards of the secondary spaced boarding are then mounted. All boards are mounted on the side of the line 5 where the “X” is located. This guarantees a correct centre to centre (C/C) distance between the boards of the secondary spaced boarding.

Since all roof trusses on their lower side are provided with measuring bands according to the present invention the mounting of the boards B of the secondary spaced boarding will take place in a simple and reliable way.

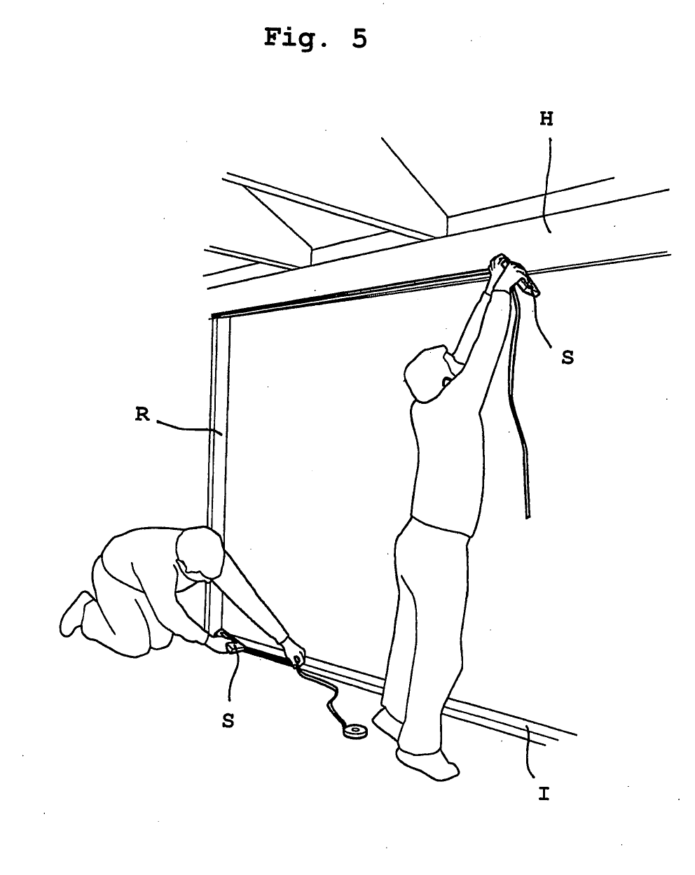

In FIG. 5 it is shown how the measuring band according to the present invention is used in connection with the erection of a wall framework. In this case it is normally the question of a centre to centre (C/C) distance of 60 cm and consequently the user cuts the measuring bands to be used at a line 3. Then every second line 3 of the measuring band is used. As is evident from FIG. 5 a first measuring band according to the present invention is mounted at the top on a top plate H of the wall framework and a second measuring band according to the present invention is mounted at the bottom on a ground plate I of the wall framework. In connection therewith the user in both cases starts from points that are located on the same plumbline. In the case shown in FIG. 5 these points are represented by a plumb starting stud R. The first and second measuring bands are attached by means of a staple gun S, see FIG. 5. When the first and second measuring bands are mounted it is extremely simple to mount the upright studs at a mutual centre to centre (C/C) distance of 60 cm. In connection therewith the upper and lower ends of a stud are placed on the side of a line 3 where the “X” is located and then the upper end of the stud is nailed or screwed to the top plate H while the lower end of the stud is mailed or screwed to the ground plate I. If the first and second measuring bands are mounted in a correct way and the ends of the studs always are placed on the side of the line 3 where the “X” is located the studs will assume a vertical position.

### FEASIBLE MODIFICATIONS OF THE INVENTION

In the embodiment described above of the measuring band according to the present invention the user may work with several different centre to centre (C/C) distances/pieces of measuring information that are multiples of each other. In the embodiment described above the measuring band may be used for three different centre to centre (C/C) distances. Within the scope of the present invention it is feasible that a measuring band is intended for only one single centre to centre (C/C) distance, e.g. 45 cm, or for two centre to centre (C/C) distances.

In the embodiment described above the measuring band according to the present invention is provided with information only on one side. However, within the scope of the present invention it is also feasible that the measuring band is provided with information on both sides. In this connection one side may be provided with several different centre to centre (C/C) distances, as described above, while the other side refers to the centre to centre (C/C) distance 45 cm.

In the embodiment described above of the measuring band according to the present invention the measuring band is equipped with a marking in the shape of an “X” on one side of each measuring indicia/line 1, 3, 5. Within the scope of the present invention it is feasible that the “X” is deleted and that for instance the stud is placed on the side of the measuring indicia/line 1, 3, 5 where there are no pieces of measuring information.

In the embodiment described above of the measuring band according to the present invention the pieces of measuring information “60” and “120” are not located at the same measuring indicia/line. The reason for making this separation is that the risk of a mix up of the centre to centre (C/C) distances is reduced. Within the scope of the invention it is feasible that the pieces of measuring information “30” and “60” are located at the same measuring indicia/line.

1. Measuring band for marking of centre to centre (C/C) distances, especially in connection with building frameworks, said measuring band at least on one side being provided with information, that the measuring band is provided with a number of measuring indicias (1, 3, 5), and that at least one piece of measuring information (30) is provided adjacent to each measuring indicia (1, 3, 5), characterised in that adjacent measuring indicias (1, 3, 5) are located at a distance from each other of at least 30 cm, and that the distance between adjacent measuring indicias (1, 3, 5) is the same.

2. Measuring band according to claim 1,
characterised in that the measuring band is disposable.

3. Measuring band according to claim 1,
characterised in that a marking symbol (X) is provided on the same side of each measuring indicia (1, 3, 5).

4. Measuring band according to claim 2,
characterised in that the measuring indicias constitute lines (1, 3, 5) transverse to the longitudinal direction of the measuring band.

5. Measuring band according to claim 1,
characterised in that several pieces of measuring information (3, 60; 30, 120) are provided adjacent to certain measuring indicias (3, 5), and that these pieces of measuring information (30, 60; 30, 120) are multiples of each other.

6. Measuring band according to claim 3,
characterised in that two pieces of measuring information are provided adjacent to certain measuring indicias (3, 5).

7. Measuring band according to claim 4,
characterised in that the marking symbol (X) is located on one side of the measuring indicia (1, 3, 5), and that the pieces of measuring information are located on the other side of the measuring indicia (1, 3, 5).

8. (Currently Amended Measuring band according to claim 1,
characterised in that the distance between adjacent measuring indicias (1, 3, 5) is 30 cm, that each measuring indicia (1, 3, 5) has the piece of measuring information “30”, that every second measuring indicia (3) has the piece of measuring information “60”, that every fourth measuring indicia (5) has the piece of measuring information “120”, and that the pieces of measuring information “60” and “120” are not located at the same measuring indicia.

9. Method for marking or centre to centre (C/C) distances between building elements by means of a measuring band, said measuring band at least on one side being provided with information, and that the measuring band is provided with a number of measuring indicias (1, 3, 5), that adjacent measuring indicias (1, 3, 5) are located at a distance from each other of at least 30 cm, that the distance between adjacent measuring indicias (1, 3, 5) is the same, characterised in that the measuring band is cut adjacent to a measuring indicia (1, 3, 5) where a piece of information regarding the centre to centre (C/C) distance is present, that the measuring band is attached to a base, said cut end being placed in the starting point of the marking, that a further cut of the measuring band is effected beyond the end point of the measuring, and that the building elements are located on the same side of the measuring indicias (1, 3, 5) where pieces of information of the centre to centre (C/C) distance in question are present.

10. Measuring band according to claim 2,
characterised in that a marking symbol (X) is provided on the same side of each measuring indicia (1, 3, 5).

11. Measuring band according to claim 1,
characterised in that the measuring indicias constitute lines (1, 3, 5) transverse to the longitudinal direction of the measuring band.

12. Measuring band according to claim 3,
characterised in that the measuring indicias constitute lines (1, 3, 5) transverse to the longitudinal direction of the measuring band.

13. Measuring band according to claim 2,
characterised in that several pieces of measuring information (3, 60; 30, 120) are provided adjacent to certain measuring indicias (3, 5), and that these pieces of measuring information (30, 60; 30, 120) are multiples of each other.

14. Measuring band according to claim 3,
characterised in that several pieces of measuring information (3, 60; 30, 120) are provided adjacent to certain measuring indicias (3, 5), and that these pieces of measuring information (30, 60; 30, 120) are multiples of each other.

15. Measuring band according to claim 4,
characterised in that several pieces of measuring information (3, 60; 30, 120) are provided adjacent to certain measuring indicias (3, 5), and that these pieces of measuring information (30, 60; 30, 120) are multiples of each other.
